(19) United States
(12) Patent Application Publication
(10) Pub. No.: US 2005/0156447 A1
(43) Pub. Date: Jul. 21, 2005

(54) Pop-up striker

(76) Inventors: Bryan Bishop, Northville, MI (US); Vasanth Suratkal, Bloomfield Hills, MI (US); Daniel Udriste, Weston, FL (US); Simon Vigdorchik, West Bloomfield, MI (US)

Correspondence Address: SHAW PITTMAN LLP, 1650 TYSONS BOULEVARD, MCLEAN, VA, 22102, US

(21) Appl. No.: 10/969,923

(22) Filed: Oct. 22, 2004

Related U.S. Application Data
(60) Provisional application No. 60/513,605, filed on Oct. 24, 2003.

(51) Int. Cl. B62D 25/10; B60J 5/00

(52) U.S. Cl. 296/76; 296/193.11; 296/146.8

(57) ABSTRACT

A pop-up striker for raising a lid, like a decklid, hood or door, of a vehicle comprises a spring for providing a pop-up force, whereby a first end of the spring is attached to a base plate. The pop-up striker further comprises a pop-up lever, which is pivoted to the base plate, whereby the pop-up lever is engaged with a second end of the spring. A striker element is secured to the base plate to restrict a pivoting movement of the pop-up lever.

This application claims the benefit of U.S. Provisional Application No. 60/513,605, filed Oct. 24, 2003, which is herein incorporated by reference in its entirety.

### BACKGROUND

1. Field of the Invention

The invention relates to a pop-up striker for raising a lid, like a decklid, which is pivoted to a body of a vehicle.

2. Background of the Invention

In general a lid of a vehicle can be locked to the body of the vehicle by a locking element. This locking element may comprise a locking striker secured to the body of the vehicle and a catch with a hook part secured to the lid. For locking the lid the catch can be moved to a first position at which the hook part is in a hook engagement with the locking striker. For unlocking the lid the catch can be moved to a second position at which the hook part is in disengagement with the striker. The catch is retained in the first position by a pivoted pawl, whereby a shoulder of the pawl is in engagement with a corresponding portion of the catch. The catch and the pawl are coupled by a coupling spring. For unlocking the lid the pawl rotates such that the retaining shoulder of the pawl disengages the catch allowing the catch to move in the second position, whereby with the help of the urging force of the coupling spring the lid is raised from the body (see e.g. U.S. Pat. No. 5,020,838).

The resulting clearance between the lid and the body is in general very small, so that fingers can hardly grasp in the clearance for opening the lid completely.

EP 0 894 919 B1 discloses a closer device for a tail gate pivotally hinged on a motor vehicle's housing. It comprises a rotary-latch lock arranged on the gate side and a latch striker associated therewith on the housing side in a housing side recess which allows the rotary-latch lock to engage when the gate is in the closed position. A cover pivots back against the force of spring during engagement of the rotary-latch lock which is provided to extensively cover the recess when the gate is open and the cover together with an associated spring arrangement is simultaneously designed as an ejector device pivoting somewhat in the direction of the open position after release by the lock arrangement. Therefore, the cover comprises a wing on each side of the latch striker. One wing is rigidly positioned at one end of a curved member which arches around the latch striker and the other wing and is pivotably mounted at its other end. A spring acts on the wing. The spring pretensions the curved member in the direction of a stop on which the curved member is supported when the gate is open. The curved member is pivotably mounted to an attachment plate at one end.

A device for fastening and opening vehicle panel to a cross member by means of a lock is disclosed in EP 0 322 266 B1. The device comprises a keeper fixed to the crossmember under an orifice made in an upper partition of the said crossmember and a latch integral with a lock part fixed to the panel and, in the fastening position, it passes through the upper partition of the crossmember via the orifice. A shutter plate for the orifice is carried by the crossmember and is laid under the upper partition of the crossmember by an elastic return means wherein the shutter plate comprises guide means and is movable in translational motion in the direction of penetration of the lock part into the orifice of the crossmember. The keeper extends in the direction of the penetration and the guide means consist of a central hole which is located in the shutter plate and in which the keeper alide. The elastic return means consists of a spring arranged round the keeper. The elastic return means may consist of the spring arranged round each column.

### BRIEF SUMMARY OF THE INVENTION

It is, therefore, the object of the present invention to provide a pop-up striker, which raises the lid of a vehicle from the body with a clearance, which is larger than corresponding clearances have been before, so that fingers can easily grasp in the clearance for opening the lid completely, after it has been unlocked.

The pop-up striker for raising a lid, like a decklid, of a vehicle comprises, according to the present invention, a spring for providing a pop-up force, whereby a first end of the spring is attached to a base plate. The pop-up striker further comprises a pop-up lever, which is pivoted to the base plate, whereby the pop-up lever is engaged with the second end of the spring. A striker element is secured to the base plate to restrict a pivoting movement of the pop-up lever.

The pop-up lever can be substantially V-shaped and can have a first end which is secured to the second end of the spring. In a preferred embodiment of the present invention the spring is preloaded so as to bias the pop-up lever against the striker element. The pop-up lever can comprise an end cap attached to a second end of the pop-up lever. The end cap is preferentially made of plastics.

In another preferred embodiment of the present invention the pop-up striker comprises a hollow cylinder enclosing the spring for guiding the spring and for dampening of spring vibrations. The hollow cylinder can be attached to the base plate.

The striker element is preferably substantially U-shaped, whereby both ends of the striker element are attached to the base plate. The pop-up lever and the striker element can be arranged such that a leg of the V-shaped pop-up lever passes through the opening defined by the striker element and the base plate.

Furthermore, it is the object of the present invention to provide a vehicle having a lid, like a deck lid, pivoted to a body of the vehicle for closing an opening of the body, the vehicle comprising a locking element for locking the lid to the body and a pop-up striker for raising the lid when it has been unlocked, the locking element secured to a portion of the body adjacent to the opening or to the lid and the pop-up striker secured to the lid or to a portion of the body adjacent to the opening.

In a preferred embodiment the locking element comprises catch means provided with a hook part, the catch means being moveable between a first position at which the hook part is in engagement with a locking striker and a second position at which the hook part is in disengagement with the locking striker, whereby the locking striker is attached to the lid and the catch means is attached to the body. In another embodiment the locking striker can be attached to the body and the catch means can be attached to the lid.

In another preferred embodiment of the vehicle according to the present invention the pop-up striker and the locking element are arranged such that the pop-up lever of the pop-up striker pushes against the catch means for raising the lid, after the locking element has been unlocked.

In a further preferred embodiment a damper restrains the pivoting movement of the pop-up lever in order to reduce the noise emission.

### BRIEF DESCRIPTION OF THE DRAWINGS

FIG. 1A is a schematic rearview on a vehicle with a decklid and a pop-up striker mounted to a body,

FIG. 1B is a schematic rearview on a vehicle with a pop-up striker mounted to a decklid,

FIG. 2 is a schematic view of a locking element,

FIG. 3 is a perspective view of a pop-up striker showing an embodiment according to the present invention,

FIG. 4 is a perspective view of the pop-up striker of FIG. 3 seen from another direction,

FIG. 5 is a perspective view of the pop-up striker seen along the direction A in FIG. 4, and

FIG. 6 is a perspective view of a pop-up striker showing a further embodiment.

### DETAILED DESCRIPTION OF THE INVENTION

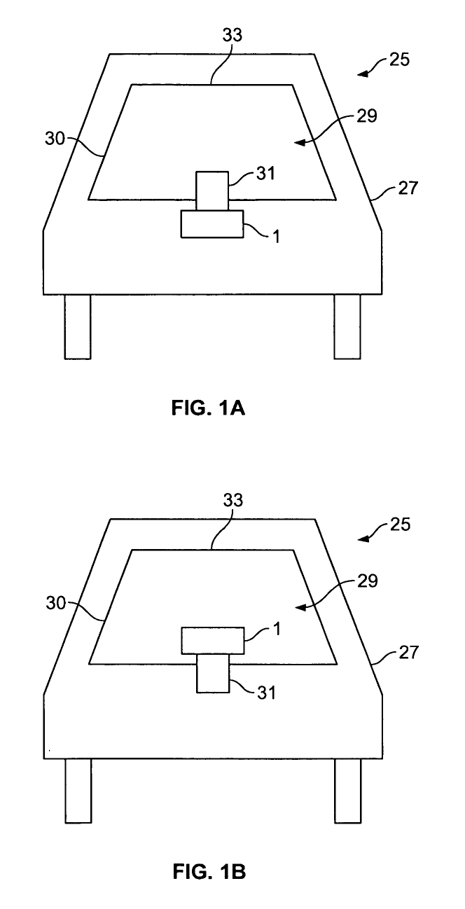

FIG. 1A shows schematically a rearview on a vehicle 25 with a decklid 29 for closing an opening 30 of a body 27 of the vehicle 25. The decklid 29 is pivoted to the body 27 at a pivot axis 33 such that the decklid 29 can be opened in an upward direction. The decklid 29 comprises a previously known locking element 31 for locking the decklid to the body 27 which comprises a pop-up striker 1 for raising the decklid 29 from the body 27, after the decklid 29 has been unlocked.

FIG. 1B shows schematically a rearview on a vehicle 25 whereby the decklid 29 comprises the pop-up striker 1 and the body 27 comprises the locking element 31.

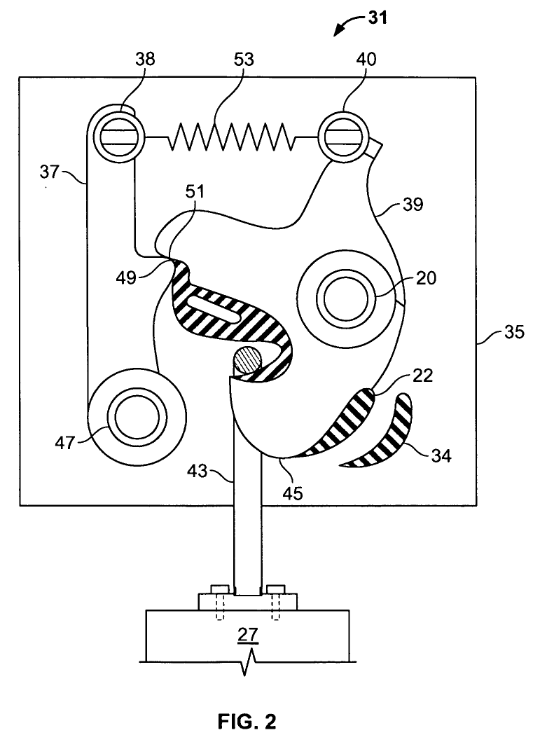

A typical locking element 31 is schematically shown in FIG. 2 together with a prior art locking striker 43. The locking element 31 comprises a catch 39 and a pawl 37 and interacts with a locking striker 43. The locking striker 43 is secured to the body 27, whereas the catch 39 and the pawl 37 are rotatably mounted on a latch frame plate 35, which is secured to the decklid 29.

The catch 39 has a hook part 45, which is in hook engagement with the locking striker 43, when the decklid 29 is locked to the body 27. The catch 39 is movable between a first position at which the hook part 45 is in hook engagement with the locking striker 43, as shown in FIG. 2, and a second position at which the hook part 45 is in disengagement with the locking striker 43. The catch 39 is rotatably mounted on a shaft 20 secured to the latch frame plate 35 and has a rubber stopper 22 which cooperates with a rubber stopper 34 attached to the latch frame plate 35 to prevent excess rotation of the catch 39.

The pawl 37 is rotatably mounted on a shaft 47 which is secured to the latch frame plate 35. At an intermediate portion of the pawl 37 a shoulder 49 is formed which is adapted to come into engagement with a shoulder 51 of the catch 39 for retaining the catch 39 at its first position.

Opposite ends of the pawl 37 and the catch 39 are coupled by a coupling spring 53. The coupling spring 53 is stretched when the catch 39 is retained in its first position (FIG. 2), thereby assuring the engagement between the pawl 37 and the catch 39. The coupling spring 53 is pivoted to the pawl 37 and the catch 39 by conventional pivoting means 38, 40.

For unlocking the decklid 29, an actuation element (not shown), which might be any conventional means known in the art, coupled to the pawl 37 rotates the pawl 37 in FIG. 2 in a counter-clockwise direction, thereby removing the shoulder 49 of the pawl 37 from the shoulder 51 of the catch 39. Since the catch 39 is being urged in the counter-clockwise direction by the coupling spring 53, the hook part 45 disengages the locking striker 43. During the unlocking procedure the catch 39 is in contact with the locking striker 43 transferring the urging force onto the locking striker 43; resulting in raising movement of the decklid 29 relative to the body 27 and a corresponding clearance.

This clearance between an edge of the decklid 29 and an edge of the body opening 30, as a result only of the above urging force, would be very small hardly allowing fingers to grasp into this clearance for opening the decklid 29 completely. Therefore, additionally a pop-up striker is attached to the body 27 in the vicinity of the locking striker 43.

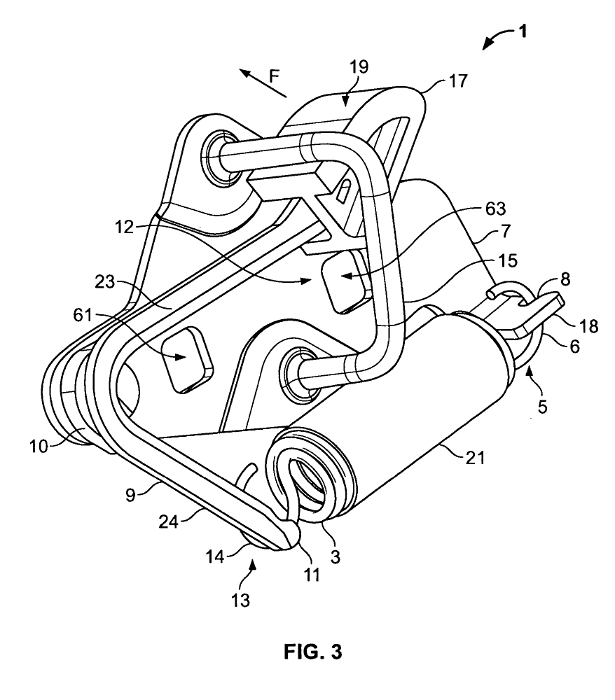

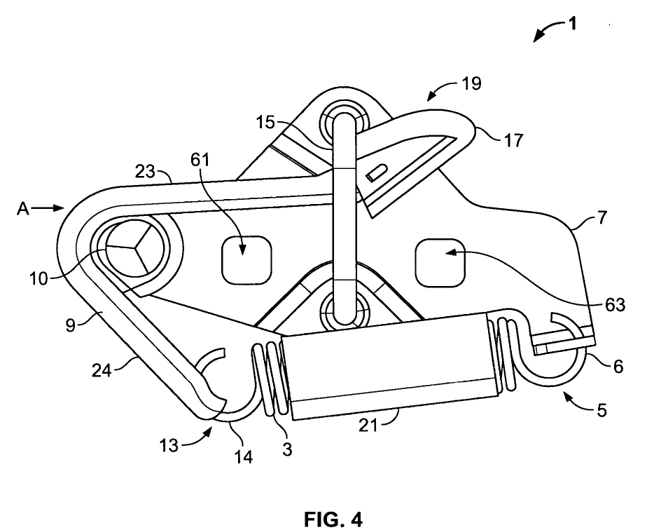

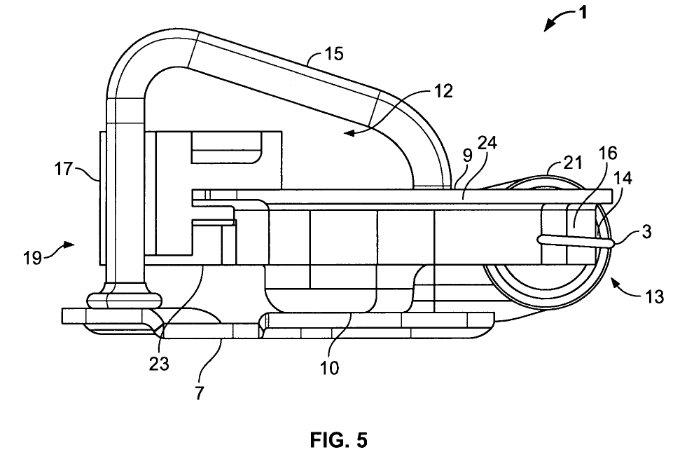

FIGS. 3-5 show a pop-up striker 1. The pop-up striker 1 comprises a base plate 7, to which a substantially U-shaped striker element 15 is secured, e.g. by welding, screwing, riveting or other securing techniques known in the art.

The pop-up striker 1 further comprises a substantially V-shaped pop-up lever 9 pivoted to the base plate 7 at a pivot position 10 by riveting. The striker element 15 and the pop-up lever 9 are arranged on the base plate 7 such that a first leg 23 of the pop-up lever 9 passes through an opening 12 defined by the striker element 15 and the base plate 7 to restrict pivoting movement of the pop-up lever 9. An end cap 17 is put on an end portion 19 of the first leg 23. The end cap 17 is adapted to apply a pushing force F against a catch 39 of the corresponding latch, against a part of the body 27, against a latch frame plate 35 or another part of the latch for lifting the decklid 29 from the body 27. The end cap 17 is made of a materials such as plastics or rubber, which avoids damaging of the body 27 and supports noise reduction.

Additionally, a spring 3 is secured to the base plate 7 for providing the pop-up force. At a first end portion 5 of the spring 3 a hook 6 is formed which is coupled with a groove 8 of an upstanding portion 18 of the base plate 7. Alternatively, the first end portion 5 of the spring 3 could be secured to the base plate 7 by welding, screwing or other known securing methods. At a second end portion 13 of the spring 3 a hook 14 is formed which is coupled with an opening 16 formed in a first end portion 11 of a second leg 24 of the pop-up lever 9. Again, the spring 3 can be coupled with the pop-up lever 9 by other methods known in the art. The spring 3 is enclosed by a hollow cylinder 21, which can be secured to the base plate 7. The hollow cylinder 21 guides the spring 3 and damps spring vibrations.

Preferably the spring 3 is preloaded in its position according to FIGS. 3-6, so as to bias the pop-up lever 9 against the striker element 15. When the lid 29 or closure panel is in the latched position, the pop-up lever 9 is depressed by the latch. This causes the spring 3 to extend and store energy. When the latch is released the energy stored in the spring 3 exerts a force on the pop-up lever 9 which exerts a force on the trunk lid in the opening direction. The load applied by the spring 3 is transferred into the lid or closure panel forcing it towards the opening direction.

Although the spring 3 in the described embodiment is shown as a tension spring, any type of spring could be provided in a suitable engagement with a pop-up lever in order to provide the required pushing force F.

The base plate 7 comprises securing elements to attach the pop-up striker 1 to the body 27. In the embodiments of FIGS. 3-6 the securing elements are two holes 61, 63 allowing to attach the base plate 7 to the body 27, e.g. with screws. The pop-up striker 1 is attached to the body 27 of the vehicle 25 and arranged such that the end portion 19 of the pop-up lever 9 pushes against a part of the decklid 29 or against the catch of the latch for raising the decklid 29 from the body 27, when the decklid 29 has been unlocked.

Contrary to the state of the art, the decklid 29 is not mainly raised by the locking element 31, but by the pop-up striker 1, which is a device separate from the locking element 31. Thus, the pop-up striker 1 can be adapted freely to achieve a clearance between the decklid 29 and the body 27 which is larger than corresponding clearances of state of the art locking elements. For example, the spring rate of the extension spring 3 can easily be adapted to the weight of the decklid 29.

Furthermore, the closing speed of the lid 29 can be controlled by the pop-up striker 1. When, during closing, the decklid 29, especially the locking element 31, of the vehicle 25 touches the pop-up lever 9 and keeps contact during further movement, the decklid 29 slows down and the following closing sound of the locking element 31 is dampened. Additionally, because of the slowed down decklid 29, the locking element 31 is less prone to damages.

It is well known that during driving of the vehicle 25 the decklid 29 moves relative to the body 27, which causes noise. The pop-up striker 1 attached to the body 27 or the decklid 29 and abutted to the other of the body 27 or the decklid 29 restricts this relative motion and thus reduces the noise caused by this motion.

The invention is not limited to the above described locking element 31. Any locking element known in the art for locking a lid to a body of a vehicle is appropriate, because the locking element and the pop-up striker are arranged separately from each other. Furthermore, a locking element can be used which does not provide any force for raising the lid form the body. Further, the invention is not limited to a decklid. Any lid for closing an opening of a vehicle is suitable for using the pop-up striker according to the present invention, e.g. a vehicle door. A lid according to the invention could be a decklid, hood or door of a vehicle.

In FIG. 1A, showing the closed position of the decklid 29, the locking element 31 is positioned adjacent to the pop-up striker 1. Alternatively, the pop-up lever can be disposed remote from the locking element 31, the pop-up lever can be integrated in the locking element 31 or the pop-up lever can be located near the pop-up striker. In this embodiment the pop-up striker 1 is attached to the body 27 of the vehicle 25, whereby the pop-up striker has to be arranged such that the pop-up lever contacts a part of the lid, when the lid is closed. For example, the pop-up striker could be mounted such that the pop-up lever pushes against the latch frame plate or a part of the locking element for lifting the lid form the body.

In FIG. 1B, as well showing the closed position of the decklid 29, the pop-up striker 1 is mounted to the decklid 29 and the locking element 31 is mounted to the body 27. The pop-up striker 1 is arranged such that the pop-up lever 9 contacts a part of the body 27, preferably the catch 39 of locking element 31 which is mounted on body 27.

The locking element can be arranged independently of the pop-up striker. If a locking element 31 of the above described type is used, the latch frame plate 35 with the catch 39 and the pawl 37 can be attached to one of the lid and the body of a vehicle, and the locking striker 43 can be attached to the other of the lid and the body.

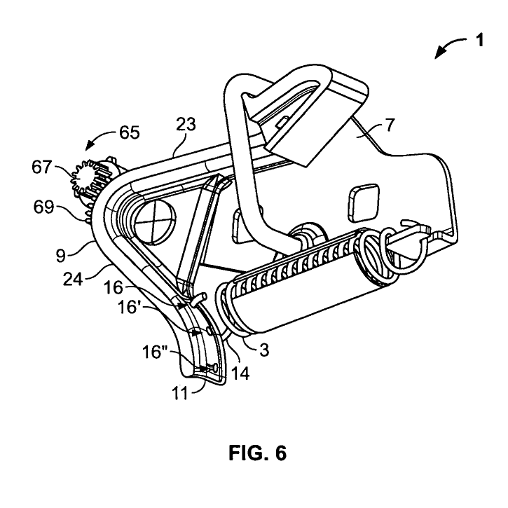

In FIG. 6 the pop-up striker 1 again is shown in the unlatched, i.e. in the open position. The pop-up efforts are adjusted by relocating spring attachment points before or after the striker 1 is installed in the vehicle. The attachment points are preferably openings 16, 16′, 16″ in the end portion 11 of pop-up lever 9. This results in a mechanism that allows one unique pop-up striker to be used in a vehicle with a trunklid that is either heavy or light. The pop-up force is adjusted by attaching the second end 13 of spring 3 to different openings 16, 16′, 16″.

Furthermore, using a pop-up lever 9 vibrations between catch 39 and striking element 15 are reduced. The closing energy absorbed by the spring will decrease the total amount of energy in the system thus decreasing the amount of energy converted to sound when the latch 39 contacts the striker element 15.

Optionally, the pop-up striker 1 has a speed control feature via a damper 65. The damper 65 preferably is attached to base plate 7. The damper 65 may comprise a toothed gear 67 fixedly mounted to the base plate 7 and meshing with toothed elements 69 which are attached at the outside of pop-up lever 9 in the region of the bend, i.e. between legs 23, 24 of the pop-up lever 9. As the outside teeth of toothed gear 67 mesh with the toothed element 69 of pop-up lever 9 the pivoting movement of pop-up lever 9 is obstructed. Therefore, toothed gear 67 is preferably fixedly mounted. Alternatively, toothed gear 67 is pivotably mounted. In this case it is advantageous to restrain the pivoting movement of the toothed gear 67.

It is also possible to use multiple pop-up strikers for raising the lid from the body yielding a larger pop-up force. Since the weight of the lid is distributed to several pop-up strikers, extension springs with smaller spring rates can be used.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

1. A pop-up striker for raising a lid of a vehicle comprising:
(a) a base plate;
(b) a spring for providing a pop-up force, the spring having a first end attached to the base plate;
(c) a pop-up lever pivotally mounted to the base plate, the pop-up lever being engaged with a second end of the spring; and
(d) a striker element secured to the base plate to restrict a pivoting movement of the pop-up lever.

2. The pop-up striker of claim 1, wherein the pop-up lever is substantially V-shaped and has a first end secured to the second end of the spring.

3. The pop-up striker of claim 1, wherein the spring is preloaded so as to bias the pop-up lever against the striker element.

4. The pop-up striker of claim 1, wherein the pop-up lever further comprises an end cap attached to a second end of the pop-up lever.

5. The pop-up striker of claim 4, wherein the end cap is made of plastic.

6. The pop-up striker of claim 1, further comprising a hollow cylinder enclosing the spring for guiding the spring and for dampening of spring vibrations.

7. The pop-up striker of claim 6, wherein the hollow cylinder is attached to the base plate.

8. The pop-up striker of claim 1, wherein the striker element has two ends and is substantially U-shaped and wherein both ends of the striker element are attached to the base plate.

9. The pop-up striker of claim 2, wherein the pop-up lever and the striker element are arranged such that a leg of the V-shaped pop-up lever passes through an opening defined by the striker element and the base plate.

10. The pop-up striker of claim 1, wherein the pop-up lever is substantially V-shaped and includes a toothed element at the outside of a bend defining the substantially V-shape, and wherein the toothed element meshes with a toothed gear mounted to the base plate.

11. The pop-up striker of claim 1, wherein the spring is a tension spring.

12. The pop-up striker of claim 1, wherein the first end of the pop-up lever includes a plurality of holes and the second end of the spring is selectively engaged with one of the plurality of holes to adjust the pop-up force of the spring.

13. A vehicle having a lid pivoted to a body of the vehicle for closing an opening of the body, the vehicle comprising:
(a) a locking element for locking the lid to the body; and
(b) the pop-up striker of claim 1 secured to one of the lid or to a portion of the body adjacent to the opening for raising the lid when it has been unlocked.

14. The vehicle of claim 13, wherein the locking element comprises catch means provided with a hook part, the catch means being movable between a first position at which the hook part is in engagement with the striking element of the pop-up striker and a second position at which the hook part is in disengagement with the striking element, the striking element being attached to the lid and the catch means being attached to the body.

15. The vehicle of claim 13, wherein the locking element comprises catch means provided with a hook part, the catch means being movable between a first position at which the hook part is in engagement with the striking element of a pop-up lever and a second position at which the hook part is in disengagement with the striking element, the striking element being attached to the body and the catch means being attached to the lid.

16. The vehicle of claim 14, wherein the catch means is attached to a latch frame plate attached to the body.

17. The vehicle of claim 15, wherein the catch means is attached to a latch frame plate attached to the lid.

18. The vehicle of claim 14, wherein the pop-up striker and the locking element are arranged such that the pop-up lever of the pop-up striker pushes against the catch means for raising the lid after the locking element has been unlocked.

19. The vehicle of claim 15, wherein the pop-up striker and the locking element are arranged such that the pop-up lever of the pop-up striker pushes against the catch means for raising the lid after the locking element has been unlocked.

20. The vehicle of claim 13, wherein the pop-up lever is substantially V-shaped and has a first end secured to the second end of the spring.

21. The vehicle of claim 13, wherein the spring is preloaded so as to bias the pop-up lever against the striker element.

22. The vehicle of claim 13, wherein the pop-up lever further comprises an end cap attached to a second end of the pop-up lever.

23. The vehicle of claim 22, wherein the end cap is made of plastic.

24. The vehicle of claim 13, further comprising a hollow cylinder enclosing the spring for guiding the spring and for dampening of spring vibrations.

25. The vehicle of claim 24, wherein the hollow cylinder is attached to the base plate.

26. The vehicle of claim 13, wherein the striker element has two ends and is substantially U-shaped and wherein both ends of the striker element are attached to the base plate.

27. The vehicle of claim 20, wherein the pop-up lever and the striker element are arranged such that a leg of the V-shaped pop-up lever passes through an opening defined by the striker element and the base plate.

28. The vehicle of claim 13, wherein the pop-up lever is substantially V-shaped and includes a toothed element at the outside of a bend defining the substantially V-shape, and wherein the toothed element meshes with a toothed gear mounted to the base plate.

29. The vehicle of claim 13, wherein the lid is one of a trunk lid, a hood, and a door.

30. The vehicle of claim 13, wherein the pop-up striker is arranged separate from the locking element.

31. A vehicle having a lid pivoted to a body of the vehicle for closing an opening of the body, the vehicle comprising:
(a) a locking striker attached to one of the lid and a portion of the body adjacent the opening;
(b) a locking element for locking the lid to the body, the locking element being attached to the other of the lid and a portion of the body, the locking element including catch means provided with a hook part, the catch means being movable between a first position at which the hook part is in engagement with the locking striker and a second position at which the hook part is in disengagement with the locking striker; and
(c) a pop-up striker secured to one of the lid and the portion of the body adjacent to the opening for raising the lid when it has been unlocked, the pop-up striker being separate from both the locking striker and the locking element.

32. The vehicle of claim 31, wherein the pop-up striker includes a base plate, a spring for providing a pop-up force, the spring having a first end attached to the base plate, a pop-up lever pivotally mounted to the base plate, the pop-up lever being engaged with a second end of the spring, and a striker element secured to the base plate to restrict a pivoting movement of the pop-up lever.

33. The vehicle of claim 32, wherein the pop-up striker and the locking element are arranged such that the pop-up lever of the pop-up striker pushes against the catch means for raising the lid after the locking element has been unlocked.

34. The vehicle of claim 32, wherein the pop-up lever is substantially V-shaped and has a first end secured to the second end of the spring.

35. The vehicle of claim 32, wherein the spring is preloaded so as to bias the pop-up lever against the striker element.

36. The vehicle of claim 32, wherein the pop-up lever further comprises an end cap attached to a second end of the pop-up lever.

37. The vehicle of claim 32, further comprising a hollow cylinder enclosing the spring for guiding the spring and for dampening of spring vibrations.

38. The vehicle of claim 37, wherein the hollow cylinder is attached to the base plate.

39. The vehicle of claim 32, wherein the striker element has two ends and is substantially U-shaped and wherein both ends of the striker element are attached to the base plate.

40. The vehicle of claim 39, wherein the pop-up lever and the striker element are arranged such that a leg of the V-shaped pop-up lever passes through an opening defined by the striker element and the base plate.

41. The vehicle of claim 32, wherein the pop-up lever is substantially V-shaped and includes a toothed element at the outside of a bend defining the substantially V-shape, and wherein the toothed element meshes with a toothed gear mounted to the base plate.

42. The vehicle of claim 31, wherein the lid is one of a trunk lid, a hood, and a door.
